(19) United States
(12) Patent Application Publication
(10) Pub. No.: US 2023/0199602 A1
(43) Pub. Date: Jun. 22, 2023

(54) TERMINAL NETWORK CONNECTION CONTROL METHOD, AND MEDIUM AND CHIP THEREFOR

(71) Applicant: HUAWEI TECHNOLOGIES CO., LTD., Shenzhen, Guangdong (CN)

(72) Inventors: Yong Li, Shanghai (CN); Hai Lian, Shenzhen (CN); Yuwei Fan, Shanghai (CN)

(73) Assignee: HUAWEI TECHNOLOGIES CO., LTD., Shenzhen, Guangdong (CN)

(21) Appl. No.: 17/926,168

(22) PCT Filed: May 18, 2021
(86) PCT No.: PCT/CN2021/094382

§ 371 Date: Nov. 18, 2022

(30) Foreign Application Priority Data
May 20, 2020 (CN) 202010431134.4

(51) Int. Cl. H04W 36/30; H04W 36/00

(52) U.S. Cl. CPC H04W 36/305; H04W 36/0069; H04W 36/0058

(57) ABSTRACT

This application relates to the field of mobile communications, and discloses a terminal network connection control method, and a medium and a chip therefor. The control method in this application includes: A terminal detects that link quality of a data link of the terminal does not meet a specified quality condition. The terminal disconnects from a 4G network in an access network when the terminal does not activate a dual connectivity function and is not in a call state, and the terminal re-requests to connect to a 5G network and the 4G network in the access network when the terminal generates a data service requirement or when signaling triggers connection establishment. The terminal disconnects from a 5G network in a first 5G serving cell when the terminal activates a dual connectivity function, and re-establishes a connection to the 5G network in a second 5G serving cell.

This application claims priority to Chinese Patent Application No. 202010431134.4, filed with the China National Intellectual Property Administration on May 20, 2020 and entitled “TERMINAL NETWORK CONNECTION CONTROL METHOD, AND MEDIUM AND CHIP THEREFOR”, which is incorporated herein by reference in its entirety.

### TECHNICAL FIELD

Embodiments of this application relate to the field of mobile terminals, and in particular, to a terminal network connection control method, and a medium and a chip therefor.

### BACKGROUND

After 5G (new radio access technology (new radio access technology, NR)) standalone (Standalone, SA)/non-standalone (Non-Standalone, NSA) networks are deployed, due to network compatibility, a problem of poor link quality of data links occurs on a terminal accessing the 5G network, and even network services are unavailable. As a result, a user has poor experience. For example, no feedback may be received in a period of time for an access request sent by an application run on the terminal.

Once the foregoing compatibility problem occurs, the terminal encounters one-way data transmission, poor data transmission quality or a high retransmission rate, and a high packet loss rate. One-way data transmission indicates that network data transmission of the terminal is in a one-way state, that is, there are only uplink data packets but no downlink data packets, or there are only downlink data packets but no uplink data packets. Usually, one-way data transmission cannot be automatically resolved.

Currently, a conventional technology for resolving the foregoing compatibility problem is a doRecovery (doRecovery) mechanism of an Android system. The doRecovery (doRecovery) mechanism is natively supported by the Android operating system. Currently, four levels of doRecovery are supported: querying an activation list, reconfiguring a route, re-registering, and enabling and disabling an airplane mode. When no feedback data is received after all applications run on the terminal send uplink data packets, the terminal device enables the doRecovery mechanism. For example, step 1: query an activation list; step 2: if no feedback data is received, reconfigure a route; step 3: if still no feedback data is received, perform re-registration; and step 4: if still no feedback data is received, enable the airplane mode and then disable the airplane mode.

However, the foregoing operations do not change a reporting capability of the terminal, and therefore cannot resolve the compatibility problem caused by 5G.

### SUMMARY

Embodiments of this application provide a terminal network connection control method, and a medium and a chip therefor, to resume, in different network architectures, data transmission between a terminal and a network by changing a network connection, and resume data transmission between the terminal and the network when a call of the terminal is maintained, so as to improve data transmission quality.

According to a first aspect, an embodiment of this application discloses a network connection control method. The method includes: A terminal detects that link quality of a data link of the terminal does not meet a specified quality condition; and the terminal performs, when the terminal does not activate a dual connectivity function and is not in a call state, a first operation to activate the dual connectivity function of the terminal, where the first operation is disconnecting, by the terminal, from a 4G network in an access network, and reconnecting to a 5G network and the 4G network in the access network; or the terminal performs, when the terminal activates a dual connectivity function, a second operation to activate the dual connectivity function of the terminal, where the second operation is disconnecting, by the terminal, from a 5G network in a first 5G serving cell, and re-establishing a connection to the 5G network in a second 5G serving cell.

To be specific, for an NSA network, when the terminal detects that the link quality of the data link is poor, if the terminal does not activate the dual connectivity function and is not in the call state, the terminal disconnects from the 4G network to which the terminal currently connects. Then, when the terminal generates a data service requirement or when signaling triggers connection establishment, the terminal re-requests to connect to a master base station, to resume an air interface link connection, and complete activation of the dual connectivity function. If the terminal activates the dual connectivity function, the terminal disconnects from the 5G network in dual connectivity, and re-establishes a 5G network connection after the master base station changes a 5G serving cell for the terminal to. It may be understood that the dual connectivity function herein means that the terminal accesses a core network through both a 4G connection and a 5G connection. The 5G serving cell is a primary secondary cell in non-standalone networking. The call state means that the terminal is in a call state of an IMS call. In the NSA network, the access network herein includes a master base station and a secondary base station. Signaling is a control instruction for communications between the terminal and a base station.

In this solution, the dual connectivity function of the terminal whose dual connectivity is not activated can be activated, so that the terminal can access the core network in a dual connectivity manner. For a terminal whose dual connectivity is activated but 5G connection is faulty and that is in a call state, the terminal can resume the 5G connection of the terminal while holding a call.

In a possible implementation of the first aspect, the control method further includes:

If the terminal performs the first operation for more than a first quantity of execution times or first execution duration, and the terminal detects that the link quality of the data link of the terminal does not meet the specified quality condition, or if the terminal performs the second operation for more than a second quantity of execution times or second execution duration, and the terminal detects that the link quality of the data link of the terminal does not meet the specified quality condition,

the terminal enables the dual connectivity function of the terminal after disabling the dual connectivity function of the terminal for first disabling duration.

That is, in this solution, if the quality of the data link of the terminal still cannot be resumed after the first operation and the second operation are performed for a plurality of times, the dual connectivity function of the terminal is disabled for a period of time and then is re-enabled. The period of time herein refers to disabling duration of disabling the dual connectivity.

In a possible implementation of the first aspect, that the terminal detects that link quality of a data link of the terminal does not meet a specified quality condition includes at least one of the following:

The terminal detects that a TCP retransmission rate is higher than a retransmission rate threshold;

the terminal detects that the terminal receives no downlink data packet or sends no uplink data packet in first preset transmission duration; and

the terminal detects that a ratio of a quantity of uplink data packets sent by the terminal in second preset transmission duration to a quantity of downlink data packets received by the terminal in the second preset transmission duration is greater than a first ratio threshold or is less than a second ratio threshold, where the first ratio threshold is greater than the second ratio threshold.

It may be understood that the first preset transmission duration and the second preset transmission duration may be equal or unequal. For example, the first preset transmission duration and the second preset transmission duration may be set as time interval thresholds, the first preset transmission duration is configured as 30 s, and the second preset transmission duration is configured as 40 s. The first ratio threshold and the second ratio threshold may be set to a specified ratio between the quantity of uplink data packets and the quantity of received downlink data packets.

In a possible implementation of the first aspect, the terminal performs the first operation in the following manner:

The terminal disconnects from the 4G network by releasing an air interface link of a master base station in the access network; and

the terminal accesses the master base station and a core network corresponding to the access network by sending a connection request to the master base station, and accesses the core network corresponding to the access network by using a secondary base station, to activate the dual connectivity function.

It may be understood that the master base station herein is a 4G base station, and the secondary base station herein is a 5G base station. After disconnecting from the 4G network, the terminal re-accesses to the core network by using the master base station and the secondary base station, to activate dual connectivity between the terminal and the core network.

In a possible implementation of the first aspect, the terminal performs the second operation in the following manner:

The terminal reports a secondary cell group failure to a master base station in the access network, and disconnects from the 5G network by disconnecting from a secondary base station in the access network;

the terminal skips, in preset sending duration, sending a neighboring cell measurement report of a secondary cell group related to the first 5G serving cell to the master base station, so that the master base station changes a 5G serving cell of the terminal from the first 5G serving cell to the second 5G serving cell; and

the terminal establishes the connection to the 5G network in the second 5G serving cell.

It may be understood that the preset sending duration herein may be pre-configurable suppression duration, for example, 10 min. To be specific, in this solution, the terminal skips sending the neighboring cell measurement report in the preset sending duration, to avoid frequent handovers of the 5G serving cell in which the terminal is located.

In a possible implementation of the first aspect, that the terminal enables the dual connectivity function of the terminal after disabling the dual connectivity function of the terminal for first disabling duration includes:

The terminal reports a secondary cell group failure to a master base station in the access network, to disconnect from a secondary base station in the access network and disable the dual connectivity function, and the terminal sends a neighboring cell measurement report of the secondary cell group to the master base station after the first disabling duration to enable the dual connectivity function; or

the terminal initiates, when the terminal is in a connection idle state, tracking area updating and reports that the terminal does not support the dual connectivity function, and after the first disabling duration, re-initiates tracking area updating and reports that the terminal supports the dual connectivity function, to enable the dual connectivity function; or

the terminal sends a detach message to a core network in the access network, to disconnect the terminal from the master base station and the core network, and disable the dual connectivity function; and the terminal establishes a connection to the master base station, and reports, by sending a first attach message to the master base station, that the terminal does not support the dual connectivity function, so that the terminal is connected only to the 4G network; the terminal sends, after the first disabling duration, a second detach message to the master base station, to disconnect the terminal from the master base station and the core network, re-establishes the connection to the master base station, and reports, by sending a second attach message to the master base station, that the terminal supports the dual connectivity function, so as to enable the dual connectivity function.

In this solution, the first disabling duration may be EN-DC disabling duration. After the first disabling duration, the terminal re-establishes dual connectivity by re-reporting the neighboring cell measurement report, re-initiating tracking area updating, and sending detach/attach information.

According to a second aspect, an embodiment of this application discloses a network connection control method, applied to a terminal. The method includes:

The terminal detects that link quality of a data link of the terminal does not meet a specified quality condition; and

the terminal performs a third operation when the terminal is not in a call state, where the third operation is disconnecting, by the terminal, from a 5G network in a 5G system of an access network, lowering a priority of a third 5G serving cell to which the terminal currently belongs, and re-establishing a connection to the 5G network in the 5G system by using a fourth 5G serving cell; or

the terminal performs a fourth operation when the terminal is in a call state, where the fourth operation is disconnecting and re-establishing, by the terminal, a data transmission session with a base station in the 5G system.

To be specific, in this solution, for an SA network, when the terminal detects that the link quality of the data link is poor, if the terminal is not in the call state, the terminal disconnects from the 5G network to which the terminal currently connects, and lowers the priority of the third 5G serving cell in which the terminal is located, so that the terminal reconnects to the base station by using a neighboring cell, namely, the fourth 5G serving cell, to access a core network. When the terminal is in the call state, the terminal disconnects a data transmission session between the terminal and the core network. In this way, the terminal can resume a 5G connection of the terminal while holding a call. In the SA network, the access network herein includes a 5G base station.

In a possible implementation of the second aspect, if the terminal performs the third operation for more than a third quantity of execution times or third execution duration, and the terminal detects that the link quality of the data link of the terminal does not meet the specified quality condition, or

if the terminal performs the fourth operation for more than a fourth quantity of execution times or fourth execution duration, and the terminal detects that the link quality of the data link of the terminal does not meet the specified quality condition,

the terminal enables a 5G function of the terminal after disabling the 5G function of the terminal for second disabling duration.

In a possible implementation of the second aspect, that the terminal detects that link quality of a data link of the terminal does not meet a specified quality condition includes at least one of the following:

The terminal detects that a TCP retransmission rate is higher than a retransmission rate threshold;

the terminal detects that the terminal receives no downlink data packet or sends no uplink data packet in first preset transmission duration; and

the terminal detects that a ratio of a quantity of uplink data packets sent by the terminal in second preset transmission duration to a quantity of downlink data packets received by the terminal in the second preset transmission duration is greater than a first ratio threshold or is less than a second ratio threshold, where the first ratio threshold is greater than the second ratio threshold.

It may be understood that the first preset transmission duration and the second preset transmission duration may be equal or unequal, and the first preset transmission duration and the second preset transmission duration may be set as time interval thresholds. The first ratio threshold and the second ratio threshold may be set to a specified ratio between the quantity of uplink data packets and the quantity of received downlink data packets.

In a possible implementation of the second aspect, the terminal performs the third operation in the following manner:

The terminal disconnects from the 5G network by releasing an air interface link of the base station in the 5G system, and lowers the priority of the third 5G serving cell by sending, to the base station, a measurement report that indicates poor signal quality of the third 5G serving cell; and

the terminal sends a connection request to the base station, to establish the connection to the 5G network by using the fourth 5G serving cell.

In this solution, the measurement report that indicates the poor signal quality of the third 5G serving cell and that is reported by the terminal includes reference signal received power of the third 5G serving cell, so that the base station in the 5G system can select a serving cell with good signal quality for the terminal based on the measurement report.

In a possible implementation of the second aspect, the terminal performs the fourth operation in the following manner:

The terminal disconnects a protocol data unit session with the core network corresponding to the access network; and

the terminal re-establishes the protocol data unit session with the core network corresponding to the access network.

In this solution, another ongoing service of the terminal may not be affected by disconnecting/establishing the data transmission session between the terminal and the core network.

In a possible implementation of the second aspect, that the terminal enables a 5G function of the terminal after disabling the 5G function of the terminal for second disabling duration includes: The terminal sends a detach message to the base station in the 5G system, to disconnect the terminal from the base station in the 5G system, and disable the 5G function of the terminal; and the terminal establishes a connection to a base station in a non-5G system, and reports, by sending a third attach message to the base station in the non-5G system, that the terminal does not support the 5G function; and the terminal sends a fourth detach message to the non-5G system after the second disabling duration, to disconnect the terminal from the base station in the non-5G system, and reports, by sending a fourth attach message to the base station in the 5G system, that the terminal supports the 5G function, to enable the 5G function of the terminal.

In this solution, the terminal is degraded from the 5G network to a 4G LTE network, so that the terminal can continue to perform a data transmission service in the 4G network, and re-establish the 5G connection to the core network after the second disabling duration. The second disabling duration herein may be a disabling time period.

According to a third aspect, an embodiment of this application discloses a computer-readable medium. The computer-readable medium stores instructions, and when the instructions are executed on a computer, the computer is enabled to perform the network connection control method according to the first aspect.

According to a fourth aspect, an embodiment of this application discloses a chip used in a terminal, including:

a memory, configured to store instructions executed by one or more processors on the chip; and

a processor, being one of the processors on the chip, configured to perform the network connection control method according to the first aspect.

### BRIEF DESCRIPTION OF DRAWINGS

FIG. 1 is a diagram of a structure of a network accessed by a terminal 100 according to some embodiments of this application;

FIG. 2(a) is a flowchart of a network connection control method performed by a terminal 100 according to some embodiments of this application;

FIG. 2(b) to FIG. 2(f) are interface diagrams of a change process of a network signal icon 1001 after a terminal 100 performs a network connection control method according to some embodiments of this application;

FIG. 3 is a flowchart of a network connection control method performed by a terminal 100 according to some embodiments of this application;

FIG. 4 is a diagram of a structure of another network accessed by a terminal 100 according to some embodiments of this application;

FIG. 5(a) is a flowchart of another network connection control method performed by a terminal 100 according to some embodiments of this application;

FIG. 5(b) to FIG. 5(f) are interface diagrams of a change process of a network signal icon 1001 after a terminal 100 performs a network connection control method according to some embodiments of this application; and

FIG. 6 is a schematic diagram of a structure that can implement functions of a terminal 100 according to some embodiments of this application.

### DESCRIPTION OF EMBODIMENTS

The following describes the technical solutions in embodiments of this application with reference to the accompanying drawings in embodiments of this application. In descriptions in embodiments of this application, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions in embodiments of this application, “a plurality of” means two or more.

To make the objectives, technical solutions, and advantages of this application clearer, the following further describes the implementations of this application in detail with reference to the accompanying drawings.

The following describes some terms in embodiments of this application, to facilitate understanding of a person skilled in the art.

An NSA network refers to a long term evolution (Long Term Evolution, LTE) core network in which a dual connectivity (Dual Connectivity, DC) function is introduced, and is a heterogeneous communications system (namely, an EN-DC system) including NR and LTE. EN-DC refers to dual connectivity (E-UTRA-NR Dual Connectivity, EN-DC) of LTE and NR. The NSA network includes two cell groups: a master cell group (Master Cell Group, MCG) and a secondary cell group (Secondary Cell Group, SCG). The master cell group includes one primary cell (Primary Cell, PCell) and one or more secondary cells (Secondary Cells, Scells), and the secondary cell group includes one primary secondary cell (Primary Secondary Cell, PSCell) and one or more secondary cells (Secondary Cells, Scells). A base station that manages the MCG is referred to as a master base station (Master eNB, MeNB), and a base station that manages the SCG is referred to as a secondary base station (Secondary eNB, SeNB). A cell herein is a coverage area of a base station. After a terminal enters the coverage area of the base station, the terminal establishes a connection to the base station, and the terminal accesses a core network by using the base station. EN-DC means that a terminal communicates with both a master base station and a secondary base station, and accesses a core network by using both the master base station and the secondary base station.

An SA network herein refers to a 5G core network. After connecting to the master base station through NR, the terminal accesses the core network through the master base station. The core network is a 5G core network, and the master base station is a 5G base station.

The terminal may also be referred to as user equipment (user equipment, UE), an access terminal, a subscriber unit, a subscriber station, a mobile station, a mobile console, a remote station, a remote terminal, a mobile device, a user terminal, a terminal, a wireless communications device, a user agent, or a user apparatus. A terminal device in embodiments of this application may be a mobile phone (mobile phone), a tablet computer (Pad), a smart printer, a train detector, a gas station detector, a computer with a wireless receiving and sending function, a virtual reality (virtual reality, VR) terminal device, an augmented reality (augmented reality, AR) terminal device, a wireless terminal in industrial control (industrial control), a wireless terminal of self-driving (self-driving), a wireless terminal in remote medical (remote medical) services, a wireless terminal in a smart grid (smart grid), a wireless terminal in transportation safety (transportation safety), a wireless terminal in a smart city (smart city), a wireless terminal in a smart home (smart home), or the like. An application scenario is not limited in embodiments of this application. In this application, the foregoing terminal device and a chip that may be disposed in the foregoing terminal device are collectively referred to as a terminal device. The following uses a terminal 100 as an example for description.

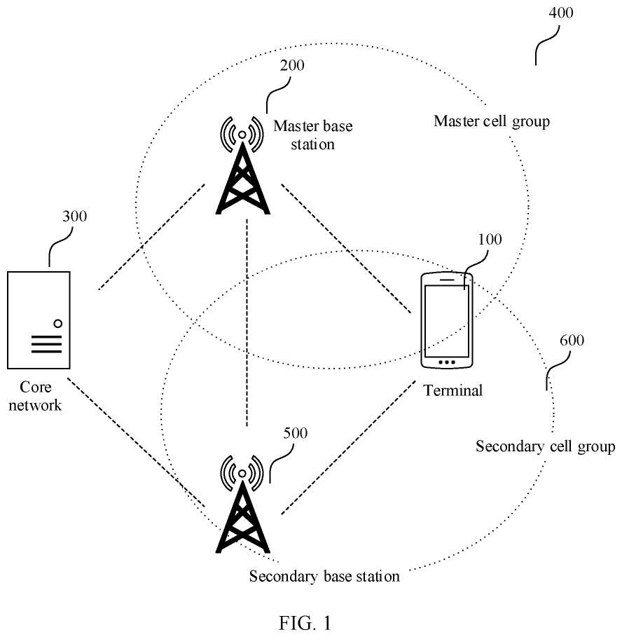

According to some embodiments of this application, in FIG. 1 and other accompanying drawings, a letter following a reference digit, for example, “100a”, indicates a reference to an element having the specific reference digit, and a reference digit without a following letter, for example, “100”, indicates a general reference to an implementation of an element with the reference digit.

An embodiment of this application provides a terminal network connection control method. When a terminal sends uplink data but receives no downlink data or a retransmission rate of TCP data is high, data transmission may be resumed by performing the following operations step by step. In an NSA network, when an EN-DC connection is not enabled and the terminal is not in an IP multimedia subsystem call connection state, the terminal actively releases an air interface link to disconnect from the NSA network. After re-accessing the NSA network, the terminal accesses a secondary cell group by reporting a 5G capability, to resume data transmission. When an EN-DC connection is enabled, the terminal sends a secondary cell group failure (Secondary Cell Group Failure, SCG Failure) and skips reporting of a measurement result of a secondary cell group in a piece of suppression duration, so that the connection between the terminal and the secondary cell group is released. After the suppression duration, the terminal re-accesses the secondary cell group through the NSA network, to resume data transmission. The terminal may alternatively resume data transmission by performing an EN-DC disabling/enabling operation. The terminal disables or enables EN-DC by sending an SCG failure message, initiating a tracking area updating (Tracking Area Updating, TAU) procedure, or initiating a detach/attach procedure, and reporting that 5G is not supported or supported, to resume data transmission. In an SA network, the terminal sends an SCG failure message to report a measurement report indicating that signal quality of a current serving cell is poor, and lowers a priority of the current cell; the terminal releases a session with a core network and uses a same session parameter to establish a new session. After invalidating a data network connection, the terminal re-enables the data network connection, and re-connects to the current serving cell by using the SA network, to resume data transmission.

As shown in FIG. 1, a master base station 200 and a secondary base station 500 are connected to a core network 300, and the master base station 200 and the secondary base station 500 are also connected to each other through an interface. After entering a primary cell of the master base station 200, the terminal 100 is connected to the master base station 200, that is, the terminal 100 accesses the core network 300 in an LTE connection manner. A master cell group 400 of the master base station 200 includes one primary cell and one or more secondary cells, and a secondary cell group 600 of the master base station 200 includes one primary secondary cell and one or more secondary cells. The core network 300 herein is a 4G core network 300. The master base station 200 is an LTE base station, the secondary base station 500 is a 5G base station, and the secondary cell group 600 is a 5G serving cell covered by the secondary base station 500. After the terminal 100 accesses the core network 300 by using the master base station 200, the master base station 200 determines, based on a capability of the terminal 100 reported by the terminal 100, for example, whether EN-DC is supported and whether a list of the secondary cell group 600 includes a cell supporting EN-DC, whether to add the secondary base station 500 for the terminal 100. If the terminal 100 supports EN-DC, and the secondary cell group 600 supporting EN-DC is configured for the master cell group 400, the master base station 200 adds a secondary base station 500 for the terminal 100, and the terminal 100 accesses the core network 300 in an EN-DC manner.

The master base station 200, the secondary base station 500, and the core network 300 each may be referred to as a network device, and the network device can communicate with a plurality of terminals (for example, the terminal 100 shown in FIG. 1). The network device may communicate with any quantity of terminals 100 that are similar to the terminal 100. However, it should be understood that the terminals 100 communicating with the network device may be the same or different. The terminal 100 shown in FIG. 1 may communicate with both the master base station 200 and the secondary base station 500. However, this shows only a possible scenario. In some scenarios, the terminal may communicate with only the master base station 200. This is not limited in this application.

The following uses QQ software run on the terminal 100 as an example to describe how to resume data transmission by using the terminal network connection control method disclosed in this application.

After the terminal 100 establishes a connection to the core network 300 by using the master base station 200, a user starts a QQ application on the terminal 100, uploads a photo 1 to a QQ web disk by using the QQ application, and selects a photo 2 from the QQ web disk and downloads the photo 2 to the terminal 100. In this case, the user finds that the photo 1 is successfully uploaded, but no download progress is made for photo 2 after 30 s. That is, the terminal 100 completes sending of uplink data stored in the terminal 100, but does not receive downlink data. Alternatively, there is download progress for the photo 2, but the download progress keeps repeating itself, that is, when the download progress reaches a specific value, the value decreases and download is repeated, and download cannot be completed. That is, the downlink data of the photo 2 is retransmitted.

For the terminal 100, an application layer on the terminal 100 detects uplink and downlink data sending and receiving status or a data retransmission rate of a TCP/IP protocol stack, to detect that no downlink data is received or the retransmission rate is high. The TCP/IP protocol stack herein means that a transmission control protocol/Internet Protocol (Transmission Control Protocol/Internet Protocol, TCP/IP) is a data transmission protocol for an end-to-end connection. The TCP retransmission rate refers to a retransmission rate of a hypertext transfer protocol (Hyper Text Transfer Protocol, HTTP) process. During network interaction, when a data field is sent each time, a timer is set for the data field. When the timer expires and no acknowledgment is received from a receiver, the data field is retransmitted. When there is no downlink data or the retransmission rate is high, the following six cases may be alternatively included.

Case 1: The user selects a photo 2 from a QQ web disk and downloads the photo 2 to the terminal 100. After 30 s, download progress of the photo 2 keeps circulating between 10% and 30%. In this case, it is considered that the TCP retransmission rate of the terminal 100 in a current network is very high. Herein, the retransmission rate of data may be calculated based on retransmitted data/valid data, and a threshold is set for the retransmission rate. When the retransmission rate exceeds the threshold, it is considered that the retransmission rate of the terminal 100 in the current network environment is high. For example, a currently set time interval threshold (Tinterval) of the terminal 100 is 30 s, and the threshold of the retransmission rate is 5. The user selects the photo 2 from the QQ web disk and downloads the photo 2 to the terminal 100. After 30 s, the download progress of the photo 2 keeps circulating between 10% and 30%, and the terminal 100 receives 6 retransmission requests within 30 s. In this case, it is considered that the TCP retransmission rate of the terminal 100 in a current network environment is very high. The time interval threshold in Case 1 may be first preset duration.

Case 2: That no downlink data is received means that the application layer on the side of the terminal 100 does not receive data sent by a base station, namely, the master base station 200. A time interval threshold may be set for a case in which no downlink data is received. After the terminal 100 sends a data request to the master base station 200 once and the time interval threshold is exceeded, if the application layer on the side of the terminal 100 still does not receive the data sent by the base station, namely, the master base station 200, it is considered that the terminal 100 has uplink data but does not have downlink data in a current network environment. For example, the time interval threshold currently set by the terminal 100 is 30 s, and the user selects a photo 2 from a QQ web disk and downloads the photo 2 to the terminal 100. After 30 s, the terminal 100 does not receive download data of the photo 2. In this case, the terminal 100 may determine that there is no downlink data between the terminal 100 and the core network 300. The time interval threshold in Case 2 may be second preset duration.

Case 3: For example, the user uses QQ software on the terminal 100 in Case 2. A time interval threshold currently set by the terminal 100 is 30 s. The user selects a photo 2 from QQ web disk and downloads the photo 2 to the terminal 100. When the photo 2 is downloaded, the user opens a QQ chat interface, after 30 s, the QQ chat interface is still in a refresh state and is not displayed. In this case, the terminal 100 may determine that there is no uplink data between the terminal 100 and the core network 300.

Case 4: The user may download a photo 2 from the QQ web disk, or may open a QQ chat interface. However, it takes 20 s from tapping the QQ chat interface by the user to displaying the chat interface. That is, the terminal 100 may receive uplink and downlink data packets at the same time, and neither the uplink data packet nor the downlink data packet is zero. However, a ratio of a quantity of uplink data packets sent by the terminal within a time interval threshold to a quantity of downlink data packets received by the terminal within the time interval threshold is greater than a specified ratio. For example, the specified ratio is 1:3, and the ratio of the quantity of uplink data packets sent by the terminal to the quantity of received downlink data packets by the terminal 100 within the time interval threshold, for example, 20 s, is 10:1.

Case 5: For example, the user downloads the photo from the QQ web disk and opens the QQ chat interface in Case 4, a ratio of a quantity of uplink data packets sent by the terminal to a quantity of downlink data packets received by the terminal 100 within a time interval threshold, for example, 20 s, is 1:10.

For Case 4 and Case 5, although the terminal 100 and the core network 300 are not in a one-way data transmission state, the quantity of downlink data packets is far greater than the quantity of uplink data packets, or the quantity of uplink data packets is far greater than the quantity of downlink data packets. In this case, the terminal 100 cannot normally receive or send data.

Case 6: A time interval threshold currently set by the terminal 100 is 30 s. The user selects a photo 2 from a QQ web disk and downloads the photo 2 to the terminal 100. Within 30 s, a download result of the photo 2 is always a download failure, and the terminal 100 determines that, in a process of downloading the photo 2, data packet loss occurs for a plurality of times. For example, a packet loss rate exceeds 50%, that is, data cannot be normally received or sent between the terminal 100 and the core network 300.

Cases 1 to 6 may be considered as that a poor link quality event occurs between the terminal 100 and the core network 300. It should be noted that specific values of the time interval threshold and the specified ratio may be adjusted based on an actual requirement, and specific values of the time interval threshold in Cases 1 to 6 may be different. This is not limited in this embodiment of this application.

The following describes a data transmission resumption method disclosed in this application in an NSA network architecture.

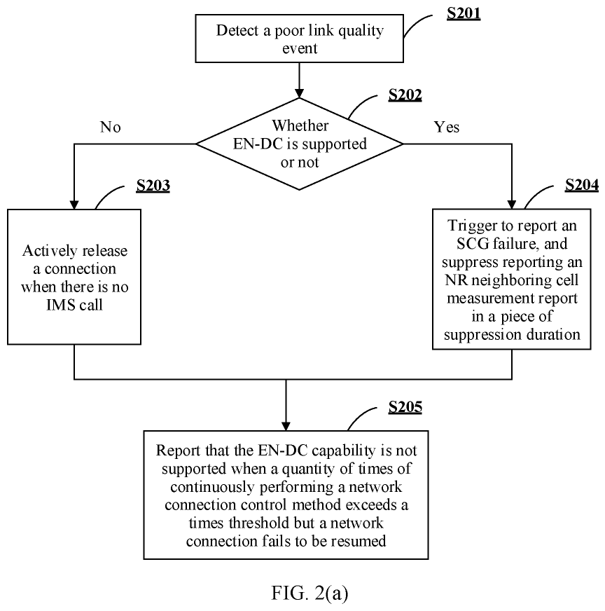

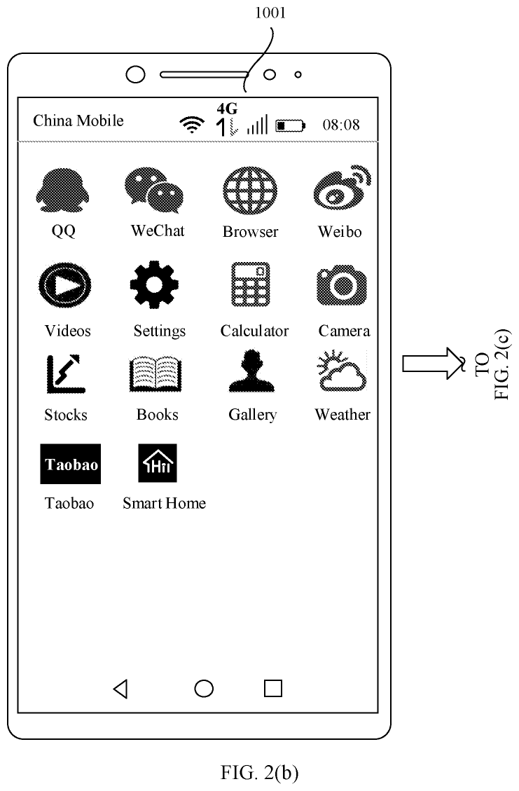

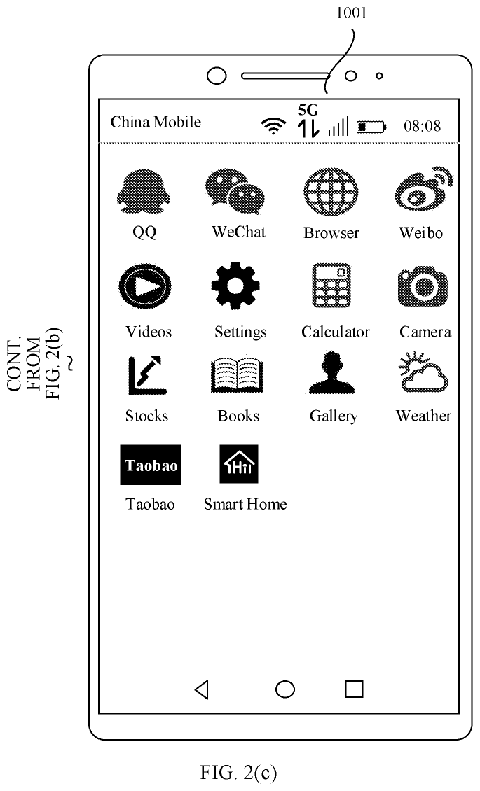

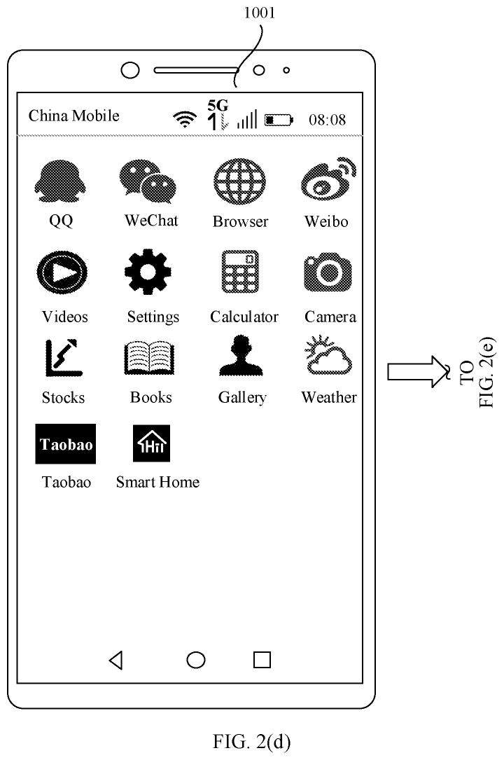

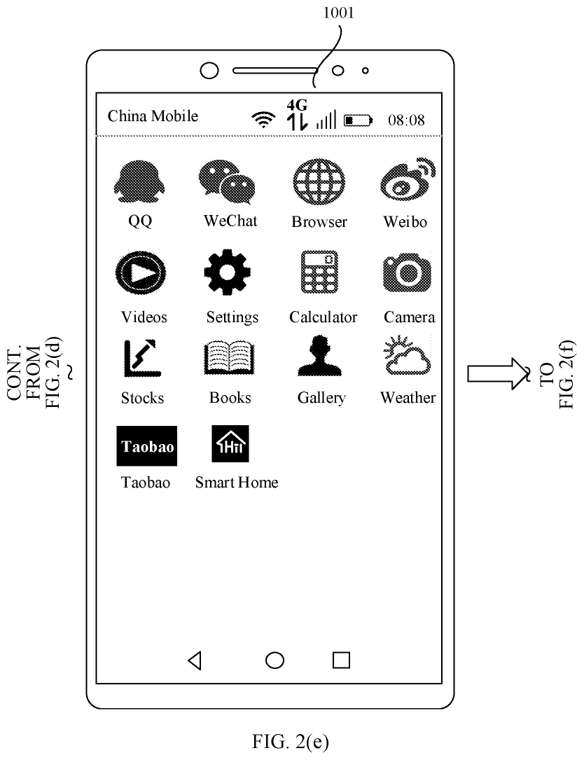

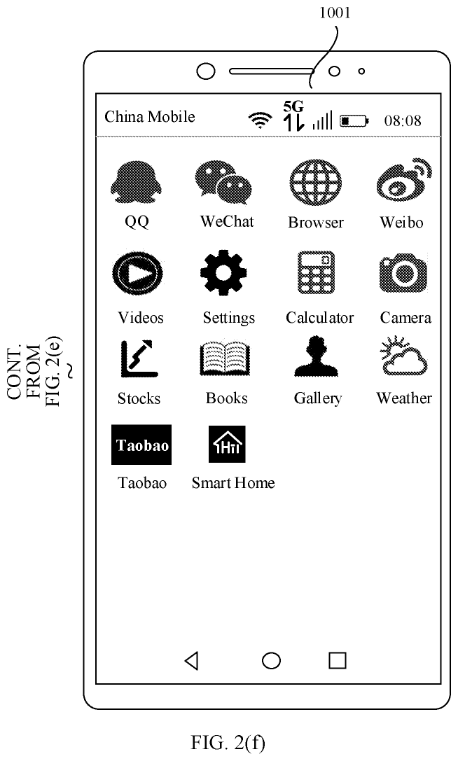

FIG. 2(a) shows that, in an NSA network architecture, after the terminal 100 detects that a poor link quality event occurs, the terminal 100 resumes data transmission by performing the terminal network connection control method. Specifically, as shown in FIG. 2(a), in the NSA network architecture, the data transmission resumption method of the terminal 100 includes the following steps.

S201: In this embodiment of this application, that the terminal 100 receives no downlink data or a TCP retransmission rate is high in a current network environment is set as a poor link quality event. The terminal 100 continuously detects two poor link quality events, that is, the terminal 100 continuously detects twice that there is no downlink data or the TCP retransmission rate is high in the current network environment. If an event occurrence time interval between the two poor link quality events is not greater than 20 s, the terminal 100 determines that the two poor link quality events are one poor link quality event. The event occurrence time interval herein is configurable. This is to avoid frequent executions of the data transmission resumption method based on a same poor link quality event. It should be noted that specific values of quantity of times (two times in the foregoing descriptions) of detected poor link quality events and the time interval (20 s in the foregoing descriptions) may be adjusted based on an actual requirement. This is not limited in this embodiment of this application. S202: In a case in which the terminal 100 is connected to the master base station 200 but is not connected to the secondary base station 500 (that is, the core network 300 does not configure EN-DC for the terminal 100), and the user does not make an IP multimedia subsystem (IP Multimedia Subsystem, IMS) call by using the terminal 100, that is, the terminal 100 is not in a call state, data transmission is resumed by performing Step 203. When the core network 300 configures EN-DC for the terminal 100 the EN-DC is in an active state, data transmission is resumed by performing Step 204.

The IMS call herein is a voice service based on an IMS network. The core network 300 is connected to the IMS network. The terminal 100 may directly perform a related service of the IMS network in the core network 300, and another service in the core network 300, for example, a data transmission service, may also be normally performed. In a case in which the user is making the IMS call by using the terminal 100, performing the following operation for resuming data transmission may cause interruption of the IMS call.

S203: Resume data transmission by releasing an air interface connection.

In some embodiments, the terminal 100 resumes data transmission by releasing the air interface connection. The terminal 100 may send a connection release message to the master base station 200, to release the air interface connection. After receiving the connection release message, the master base station 200 releases the air interface connection. The master base station 200 deletes locally stored related information of the terminal 100, including a connection configuration, information about the terminal 100, and the like. The master base station 200 sends, to the core network 300, a message that the terminal 100 releases the air interface connection, to notify the core network 300 to delete the information about the terminal 100. The related information about the air interface connection locally stored in the terminal 100 may be alternatively locally deleted on the terminal 100.

After releasing the air interface connection, the terminal 100 may initiate an access process in a cell included in the master base station 200, and send a connection request to the master base station 200. In addition, the terminal 100 reports that an EN-DC capability is supported.

After the terminal 100 establishes a connection to the master base station 200, the master base station 200 adds a secondary base station 500 for the terminal 100. After accessing the core network 300 in an EN-DC manner, the terminal 100 resumes data transmission. In this process, a network signal icon 1001 of the terminal 100 may be shown in FIG. 2(b) and FIG. 2(c). FIG. 2(b) is used to indicate that the terminal 100 currently does not activate EN-DC. FIG. 2(c) is used to indicate that the terminal 100 activates EN-DC and resumes normal data transmission after performing network connection control.

S204: Report an SCG failure of the secondary cell group 600 to resume data transmission, to improve data transmission quality.

In another embodiment of this application, when the terminal 100 is connected to one master base station 200 and one secondary base station 500, that is, the core network 300 configures EN-DC for the terminal 100 and EN-DC is in an active state. After the terminal 100 determines that a poor link quality event occurs, the terminal 100 may resume data transmission by reporting an SCG failure of the secondary cell group 600 to the master base station 200. The terminal 100 may actively report the SCG failure of the secondary cell group 600 to the master base station 200. The SCG failure of the secondary cell group 600 may cause the terminal 100 to actively disconnect a network connection between the terminal 100 and the secondary base station 500, that is, release a connection between the terminal and the secondary cell group 600. In this case, the terminal 100 is still located in the secondary cell group 600 of the secondary base station 500. Usually, the terminal 100 further sends a primary secondary cell measurement report and a neighboring cell measurement report of the secondary cell group 600 to the master base station 200, so that the master base station 200 performs a primary secondary cell change based on the primary secondary cell measurement report and the neighboring cell measurement report of the secondary cell group 600, to connect the terminal 100 to the secondary base station 500 again. Because the terminal 100 actively reports the SCG failure of the secondary cell group 600 to the master base station 200, after comparing the primary secondary cell measurement report with the neighboring cell measurement report of the secondary cell group 600, the master base station 200 selects an original primary secondary cell as a primary secondary cell again. Therefore, the terminal 100 further skips, based on pre-configurable suppression duration (Tmeas_reposrt), for example, 10 min, the terminal 100 from reporting the neighboring cell measurement report of the secondary cell group 600 to the master base station 200. In the suppression duration, the master base station 200 cannot send a primary secondary cell modification request message to the secondary base station 500 by comparing the primary secondary cell measurement report with the neighboring cell measurement report of the secondary cell group 600, so that the secondary base station 500 does not send a reconfiguration message to the terminal 100.

The SCG failure of the secondary cell group 600 herein usually occurs when a network between the terminal 100 and the secondary base station 500 is disconnected. After receiving the primary secondary cell measurement report and the neighboring cell measurement report of the secondary cell group 600 that are sent by the terminal 100, the master base station 200 may determine a difference between reference signal received power (Reference Signal Receiving Power, RSRP) of the neighboring cell and reference signal received power of the primary secondary cell, to determine whether to perform the primary secondary cell change.

Then, after the suppression duration (Tmeas_reposrt), namely, 10 min, is over, the terminal 100 sends the neighboring cell measurement report of the secondary cell group 600 to the master base station 200, the master base station 200 performs the primary secondary cell change based on the primary secondary cell measurement report and the neighboring cell measurement report of the secondary cell group 600 that are received before the suppression duration. The terminal 100 initiates an access process by using a changed primary secondary cell. After a connection is established, the secondary base station 500 connects the terminal 100 to the core network 300. After the connection is established, data transmission between the terminal 100 and the core network 300 may be resumed.

In this process, the network signal icon 1001 of the terminal 100 may be shown in FIG. 2(d) to FIG. 2(f). FIG. 2(d) is used to indicate that the terminal 100 currently activates EN-DC. FIG. 2(f) is used to indicate that the terminal 100 disconnects from an NR system after the connection between the terminal 100 and the secondary cell group (SCG) is released, and the terminal 100 is in a 4G network. FIG. 2(f) is used to indicate that the terminal 100 activates EN-DC and resumes normal data transmission after the terminal 100 resumes data transmission.

S205: When a quantity of times of performing the data transmission resumption operation in S203 and/or S204 after the poor link quality event occurs is greater than a times threshold (N), the data transmission still cannot be resumed, the terminal 100 may disable EN-DC based on preset EN-DC disabling duration (Tno_endc_cap), and then enable EN-DC, to resume data transmission. The times threshold herein may be configurable. For example, the times threshold is set to 4. After there is no downlink data or the TCP retransmission rate is high and the terminal 100 performs the operation of resuming data transmission for more than four times, the terminal 100 may disable EN-DC based on the preset EN-DC disabling duration, and then enable EN-DC. The EN-DC disabling duration herein may be configurable, for example, may be 30 min.

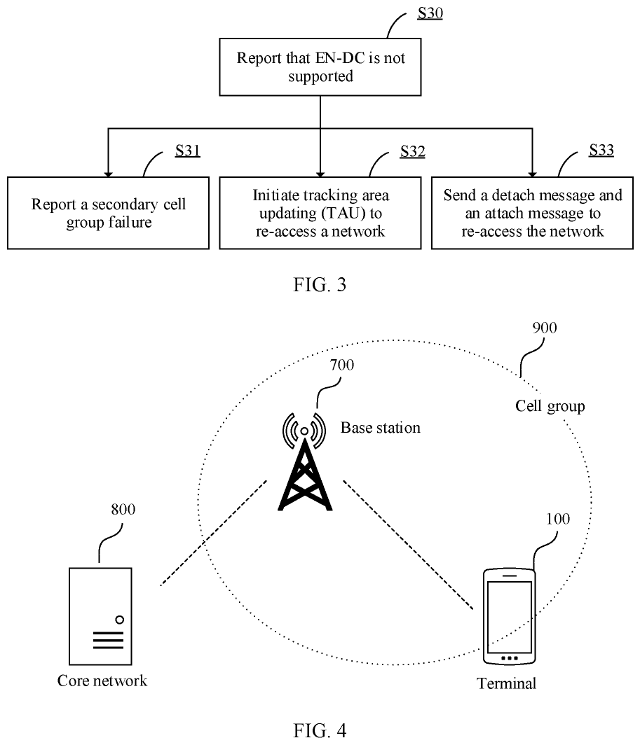

As shown in FIG. 3, the following describes that the terminal 100 resumes data transmission by disabling/enabling EN-DC.

S31: In an embodiment of this application, the terminal 100 may actively report an SCG failure of the secondary cell group 600 to the master base station 200, and may actively disconnect a network connection between the terminal 100 and the secondary base station 500, and delete the primary secondary cell from a cell list stored in the terminal 100. Herein, a method for reporting the SCG failure of the secondary cell group 600 by the terminal 100 is the same as that described above, that is, the terminal 100 is suppressed from reporting a neighboring cell measurement report of the secondary cell group 600. Details are not described herein again. In some embodiments of this application, the terminal 100 may alternatively not start a random access function of an NR system, so that the terminal 100 cannot access the secondary cell group 600 in an automatic network search manner. Alternatively, when the core network 300 sends, to the terminal 100, a message for querying a capability of the terminal 100, the terminal 100 sends, to the core network 300, capability information of the terminal 100 that does not support the EN-DC.

S32: In another embodiment of this application, when the terminal 100 is in an idle (IDLE) state, disable EN-DC by initiating TAU. There is no any uplink physical channel connection between the terminal 100 and the core network 300 when the terminal 100 is in the idle state. When the terminal 100 is in the state, the terminal 100 may listen to a broadcast channel, and maintain and update system information of a serving cell. Because the terminal 100 does not leave a current cell, when the terminal 100 detects an original primary secondary cell again, the terminal 100 may re-select a cell.

Then, after sending a connection establishment request to the master base station 200 to reestablish a connection to the master base station 200, the terminal 100 sends a TAU request to the master base station 200, reports the capability of the terminal 100 to the core network 300 by using the master base station 200, and adds “UE radio capability information update needed IE” to a TRACKING AREA UPDATE REQ message sent to the core network 300, to indicate the core network 300 to re-query the capability of the terminal 100. After the core network 300 receives the message sent by the terminal 100 for re-querying the capability of the terminal 100, the core network 300 sends, to the terminal 100, the message for querying the capability of the terminal 100. After the terminal 100 receives the message for querying the capability of the terminal 100, the terminal 100 sends, to the core network 300, the capability information of the terminal 100 that does not support EN-DC.

If the terminal 100 is in a connected (CONNECTED) state, an operation of initiating TAU may be performed after the terminal 100 switches from the connected state to the idle state.

S33: In another embodiment of this application, the terminal 100 in the connected state may alternatively send a detach message (detach message) to the core network 300 by using the master base station 200, to disable EN-DC. The message sent by the terminal 100 includes detach information. After receiving the detach message, the core network 300 sends a connection release message to the master base station 200, to release a connection between the terminal 100 and the core network 300 and a connection between the terminal 100 and the master base station 200, so that the terminal 100 switches to the idle state. In addition, the core network 300 deletes related information of the terminal 100 from a stored list of the terminal 100.

Then, after sending the connection establishment request to the master base station 200 to re-establish the connection to the master base station 200, the terminal 100 may send an attach message (attach message) to the core network 300 by using the master base station 200. After the core network 300 receives the attach message sent by the terminal 100, the core network 300 sends the message for querying the capability of the terminal 100 to the terminal 100. After the terminal 100 receives the message for querying the capability of the terminal 100, the terminal 100 sends, to the core network 300, the capability information of the terminal 100 that does not support EN-DC.

After completing the foregoing operation of disabling EN-DC, the terminal 100 may enable EN-DC again, to resume data transmission between the terminal 100 and the core network 300. The following describes a method for enabling EN-DC by the terminal 100.

In an embodiment of this application, by performing S31, the terminal 100 may actively report the SCG failure. After the terminal is disconnected from the primary secondary cell 600, and the terminal 100 reports the neighboring cell measurement report of the secondary cell group 600, an NR network side may compare RSRP of a neighboring cell with RSRP of the current primary secondary cell 600. Then, the primary secondary cell 600 may be changed. After a primary secondary cell 600 is determined, the terminal 100 establishes a connection to the secondary base station 500 by using the primary secondary cell 600, the terminal 100 accesses the core network 300 by using the secondary base station 500, and data transmission between the terminal 100 and the core network 300 may be resumed.

In another embodiment of this application, through performing S32, after the terminal 100 sends the capability information of the terminal 100 that does not support EN-DC to the core network 300 in a TAU manner, the terminal 100 may re-access a network by re-initiating TAU. The core network 300 sends, to the terminal 100, the message for querying the capability of the terminal 100. After receiving the message for querying the capability of the terminal 100, the terminal 100 sends, by using the master base station 200, capability information of the terminal 100 that supports EN-DC to the core network 300, then the terminal 100 may access the core network 300 by using the secondary base station 500, and data transmission between the terminal 100 and the core network 300 may be resumed.

In another embodiment of this application, after EN-DC is disabled between the terminal 100 and the core network 300 by performing S33, the terminal 100 accesses the core network 300 in a 4G LTE manner. In this case, the terminal 100 may re-send the detach message (detach message) to the core network 300 by using the master base station 200, to disconnect a 4G LTE connection. Then, the terminal 100 is connected to the master base station 200, and the terminal 100 sends the attach message to the core network 300 by using the master base station 200. After the core network 300 receives the attach message, the core network 300 sends, to the terminal 100, the message for querying the capability of the terminal 100. After receiving the message for querying the capability of the terminal 100, the terminal 100 sends, to the core network 300, capability information of the terminal 100 that supports EN-DC, then the terminal 100 may access the core network 300 by using the secondary base station 500, and data transmission between the terminal 100 and the core network 300 may be resumed.

In the foregoing process of S31 to S33, a changing process of the network signal icon 1001 of the terminal 100 is the same as that in S204.

In an NSA network architecture, after a poor link quality event occurs on the terminal 100, data transmission between the terminal 100 and the core network 300 may be resumed by performing the foregoing operations.

In an SA network architecture, data transmission is resumed by using the terminal network connection control method disclosed in this application.

As shown in FIG. 4, a base station 700 is connected to a core network 800. After the terminal 100 enters a cell group 900 covered by the base station 700 and is connected to the base station 700, the terminal 100 accesses the core network 800 by using the base station 700. The cell group 900 of the base station 700 includes one primary cell and one or more secondary cells. The core network 800 shown in FIG. 4 is a 5G core network, and the base station 700 is a 5G base station.

After a data service of the terminal 100 is activated, the terminal 100 monitors a data transmission status of an NR system. After the terminal 100 detects a poor link quality event, the terminal 100 performs an operation of resuming data transmission.

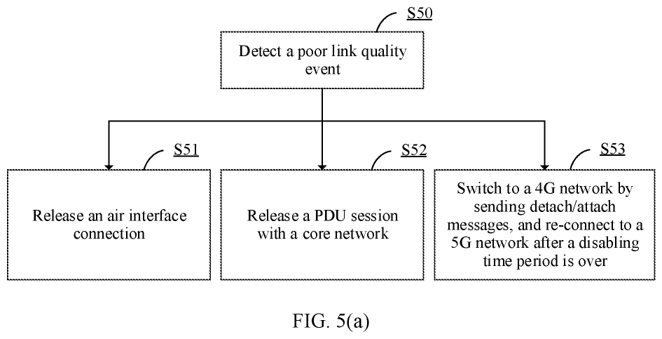

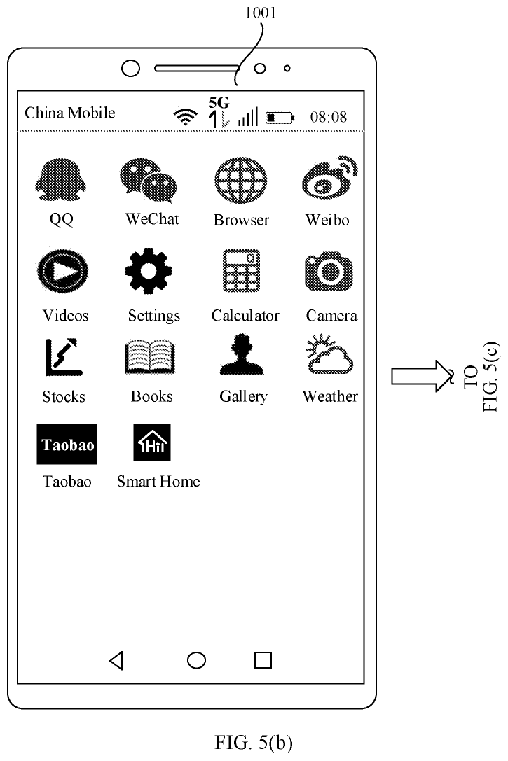

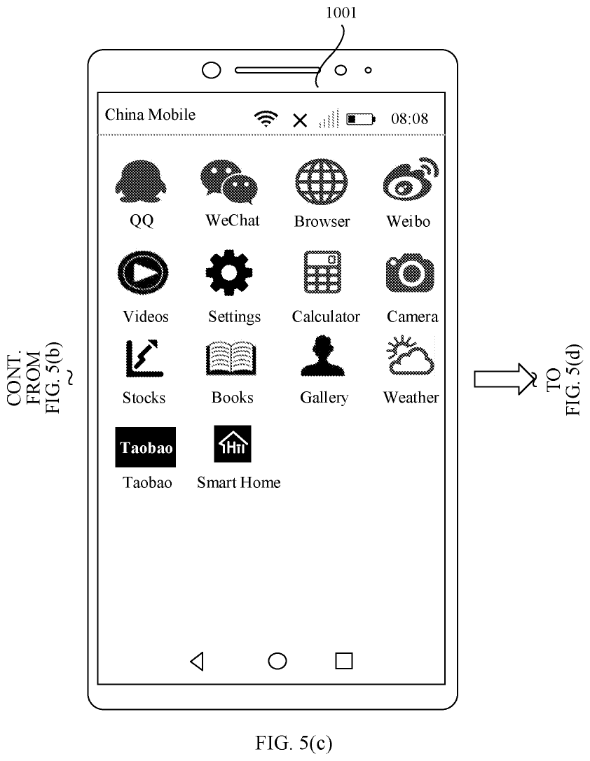

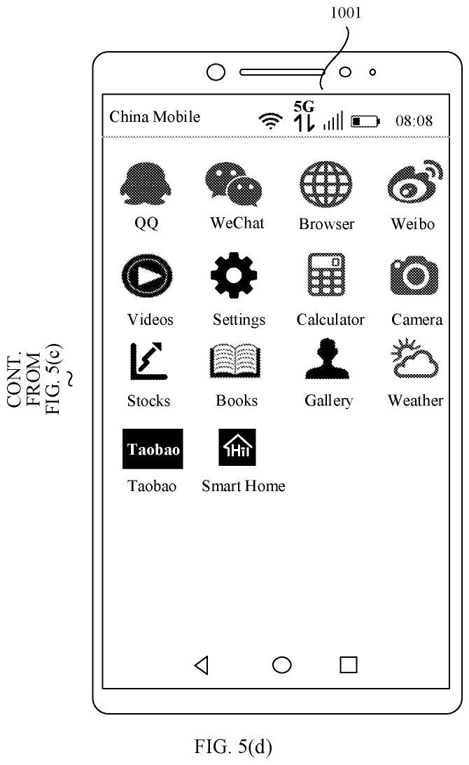

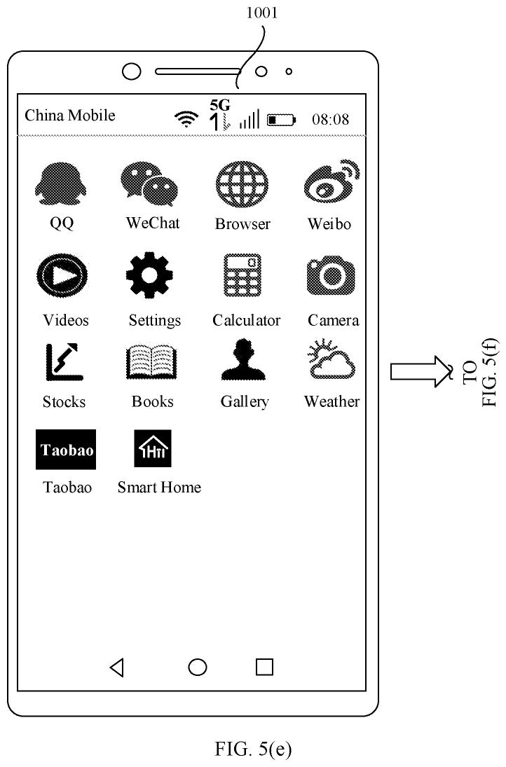

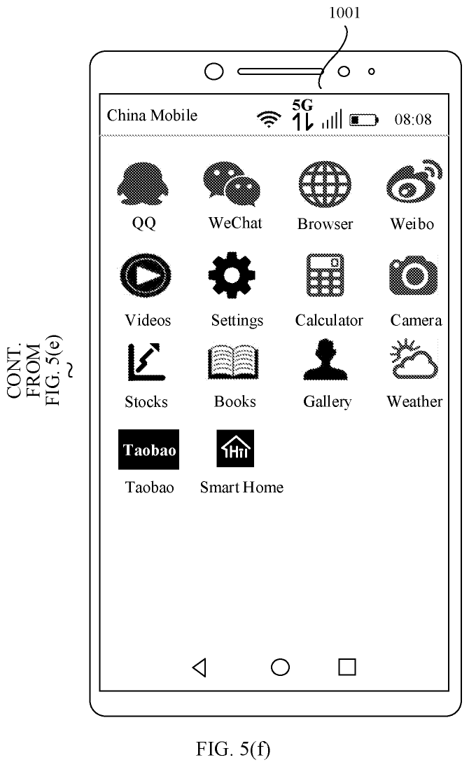

FIG. 5(a) shows that, in the SA network architecture, the terminal 100 resumes data transmission by performing the terminal network connection control method.

S50: The terminal 100 detects a poor link quality event.

S51: When a user does not use the terminal 100 to make an IMS call, the terminal 100 resumes data transmission by releasing an air interface connection between the base station 700 and the terminal 100.

Herein, an operation of releasing the air interface connection between the terminal 100 and the base station 700 is the same as that described in S203 in FIG. 2(a), and details are not described herein again. When the base station 700 releases the air interface connection after receiving a connection release message, the terminal 100 reports a measurement report of a current serving cell to the base station 700, where the measurement report indicates that signal quality of the serving cell is poor. After receiving the report, the base station 700 may lower a priority of a serving cell on which the terminal 100 previously camps.

After the terminal 100 releases the air interface connection, the terminal 100 initiates an access process in the cell group 900 included in the base station 700, and sends a connection request to the base station 700. Because the priority of the serving cell on which the terminal 100 camps before releasing the air interface connection is low, the terminal 100 may choose to access another cell in the cell group 900 included in the base station 700. If access succeeds, the base station 700 sends connection establishment signaling to the terminal 100. After a connection is established, the base station 700 connects the terminal 100 to the core network 800. After the connection is established, data transmission between the terminal 100 and the core network 800 may start.

In this process, the network signal icon 1001 of the terminal 100 may be shown in FIG. 5(b) to FIG. 5(d). FIG. 5(b) is used to indicate that the terminal 100 is currently in a 5G network connection, and a poor link quality event occurs. FIG. 5(c) is used to indicate that the terminal 100 disconnects from an NR system after the connection between the terminal 100 and the serving cell is released, and the terminal 100 is not connected to a network. FIG. 5(d) is used to indicate that the terminal 100 re-establishes a 5G network connection with normal data transmission after the terminal 100 resumes data transmission.

S52: In another embodiment of this application, the user makes an IMS call by using the terminal 100. The IMS call herein is a voice service based on an IMS network. The 5G core network 800 is connected to the IMS network, the terminal 100 may directly perform an IMS service in the 5G network, and a service on the 5G network may be appropriately processed.

In this case, when the terminal 100 detects that a poor link quality event occurs in the current NR system, the terminal 100 actively releases a protocol data unit (Protocol Data Unit, PDU) session for data transmission other than the IMS service between the terminal 100 and the core network 800, and establishes a new PDU session by using a same session parameter (for example, a DNN/S-NSSAI), to resume data transmission between an application layer of the terminal 100 and the core network 800. The DNN (Data Network Name, data network name) herein includes a network ID or an operator name. For S-NSSAI (Single Network Slice Selection Assistance Information, single network slice selection assistance information), when the core network 800 has a plurality of network slices, each network slice has corresponding S-NSSAI. When the terminal 100 initially accesses the 5G core network 800, if the terminal 100 sends S-NSSAI or a DNN at the same time, the 5G core network 800 enables the terminal 100 to access a slice that is of the core network 800 and that is corresponding to the S-NSSAI or the DNN. When the terminal 100 accesses the 5G core network 800 again and sends the S-NSSAI or the DNN at the same time, a same session is established between the 5G core network 800 and the terminal 100. The network slice herein means that one physical network is divided into a plurality of virtual logical networks, and each network corresponds to a different application scenario.

In this process, the network signal icon 1001 of the terminal 100 may be shown in FIG. 5(e) and FIG. 5(f). FIG. 5(e) is used to indicate that the terminal 100 is currently in a 5G network connection, and a poor link quality event occurs. FIG. 5(f) is used to indicate that, after the terminal 100 re-establishes the data transmission session with the NR system, normal data transmission is resumed.

S53: After the terminal 100 performs the foregoing operations to re-access the core network 800, when the terminal 100 detects that a poor link quality event occurs again in the NR system, the terminal 100 may send a detach message to the core network 800 by using the base station 700, to disconnect the 5G connection between the terminal 100 and the core network 800. Then, the terminal 100 may send an attach message to the base station 700. After receiving the attach message, the core network 800 sends, to the terminal 100, a message for querying a capability of the terminal 100. After receiving the message for querying the capability of the terminal 100, the terminal 100 may send, to the core network 800, capability information of the terminal 100 that does not support 5G or that does not support NR. In this case, the terminal 100 no longer accesses the 5G network, but connects to a non-5G system, for example, degrades from the 5G network to a 4G LTE network. In addition, the terminal 100 may further keep accessing the 4G LTE network in a preset disabling time period (Tdisable_nr), for example, 30 min. When the disabling time period is over, the terminal 100 may disconnect from the 4G LTE network by sending a detach message to the 4G LTE core network. Then, the terminal 100 sends an attach message to the core network 800 by using the base station 700 again. After the core network 800 receives the attach message, the core network 800 sends the message for querying the capability of the terminal 100 to the terminal 100. After the terminal 100 receives the message for querying the capability of the terminal 100, the terminal 100 sends capability information of the terminal 100 that supports 5G or supports NR to the core network 800. Then, the terminal 100 may re-connect to the base station 700 by using the cell group 900, and resume data transmission after connecting to the core network 800.

In this process, a changing process of the network signal icon 1001 of the terminal 100 is the same as that in S51.

In addition to 5G and LTE NR EN-DC network access technologies, the technical solutions in embodiments of this application are also applicable to network access technologies such as GSM/UMTS/TDS/LTE.

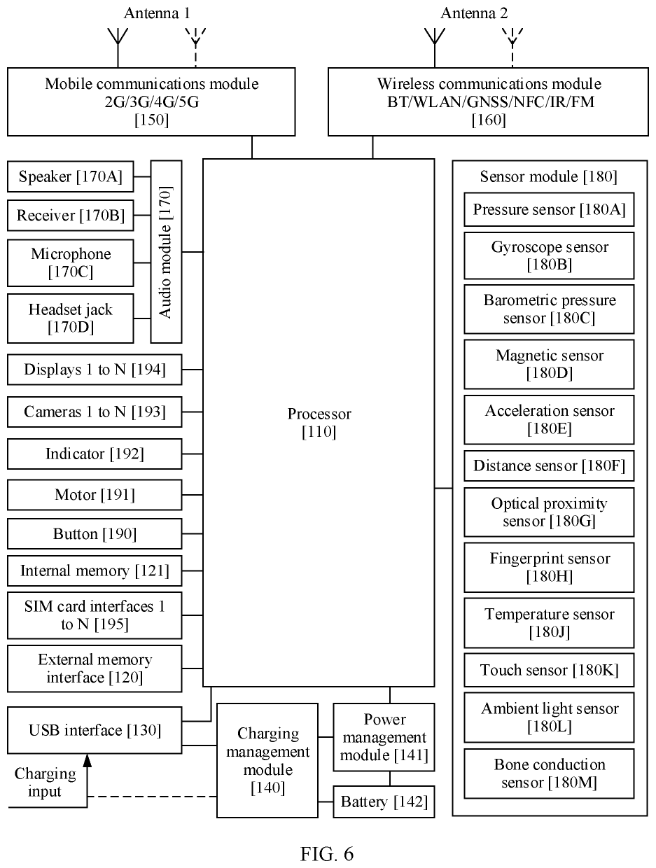

FIG. 6 is a schematic diagram of a structure of a terminal 100 applicable to this application. It may be understood that the structure shown in FIG. 6 may also be another mobile terminal. As shown in FIG. 6, the terminal 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It should be understood that the hardware structure shown in FIG. 6 is merely an example. The terminal 100 in this embodiment of this application may have more or fewer components than those shown in FIG. 6, may combine two or more components, or may have a different component configuration. Various components shown in FIG. 6 may be implemented by hardware that includes one or more signal processing and/or application-specific integrated circuits, software, or a combination of hardware and software.

The processor 110 may include one or more processing units. For example, the processor 110 may include an application processor (Application Processor, AP), a modem processor, a graphics processing unit (Graphics Processing Unit, GPU), an image signal processor (Image Signal Processor, ISP), a controller, a memory, a video codec, a digital signal processor (Digital Signal Processor, DSP), a baseband processor, and/or a neural-network processing unit (Neural-network Processing Unit, NPU), and/or the like. Different processing units may be independent components, or may be integrated into one or more processors. The controller may be a nerve center and a command center of the terminal device. The controller may generate an operation control signal based on an instruction operation code and a time sequence signal, to complete control of instruction fetching and instruction execution.

The controller may generate an operation control signal based on an instruction operation code and a time sequence signal, to complete control of instruction fetching and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or data again, the processor 110 may directly invoke the instructions or data from the memory, to avoid repeated access and reduce a waiting time of the processor 110. Therefore, system efficiency can be improved.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The I2C interface is a two-way synchronization serial bus, and includes one serial data line (serial data line, SDA) and one serial clock line (serial clock line, SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the terminal 100.

The I2S interface may be configured to perform audio communication. In some embodiments, the processor 110 may include a plurality of groups of I2S buses. The processor 110 may be coupled to the audio module 170 through the I2S bus, to implement communications between the processor 110 and the audio module 170. In some embodiments, the audio module 170 may transmit an audio signal to the wireless communications module 160 through the I2S interface, to implement a function of answering a call through a Bluetooth headset.

The PCM interface may also be used to perform audio communication, and sample, quantize, and code an analog signal. In some embodiments, the audio module 170 may be coupled to the wireless communications module 160 through a PCM bus interface. In some embodiments, the audio module 170 may also transmit an audio signal to the wireless communications module 160 through the PCM interface, to implement a function of answering a call through a Bluetooth headset. Both the I2S interface and the PCM interface may be used for audio communication.

The UART interface is a universal serial data bus, and is configured to perform asynchronous communication. The bus may be a two-way communications bus. The bus converts to-be-transmitted data between serial communications and parallel communications. In some embodiments, the UART interface is usually configured to connect the processor 110 to the wireless communications module 160. For example, the processor 110 communicates with a Bluetooth module in the wireless communications module 160 through the UART interface, to implement a Bluetooth function. In some embodiments, the audio module 170 may transmit an audio signal to the wireless communications module 160 through the UART interface, to implement a function of playing music through a Bluetooth headset.

The MIPI interface may be configured to connect the processor 110 to a peripheral component such as the display 194 or the camera 193. The MIPI interface includes a camera serial interface (camera serial interface, CSI), a display serial interface (display serial interface, DSI), and the like. In some embodiments, the processor 110 communicates with the camera 193 through the CSI, to implement a photographing function of the terminal 100. The processor 110 communicates with the display 194 through the DSI, to implement a display function of the terminal 100.

The GPIO interface may be configured by software. The GPIO interface may be configured as a control signal or a data signal. In some embodiments, the GPIO interface may be configured to connect the processor 110 to the camera 193, the display 194, the wireless communications module 160, the audio module 170, the sensor module 180, or the like The GPIO interface may alternatively be configured as an I2C interface, an I2S interface, a UART interface, an MIPI interface, or the like.

The USB interface 130 is an interface that conforms to a USB standard specification, and may be specifically a mini USB interface, a micro USB interface, a USB Type-C interface, or the like. The USB interface 130 may be configured to connect to a charger to charge the electronic device 100, or may be configured to transmit data between the electronic device 100 and a peripheral device, or may be configured to connect to a headset for playing audio through the headset. The interface may be further configured to connect to another electronic device.

It may be understood that an interface connection relationship between the modules illustrated in embodiments of this application is merely an example for description, and does not constitute a limitation on a structure of the terminal 100. In some other embodiments of this application, the terminal 100 may alternatively use an interface connection manner different from that in the foregoing embodiment, or use a combination of a plurality of interface connection manners.

The charging management module 140 is configured to receive a charging input from the charger. The charging management module 140 supplies power to the terminal 100 through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communications module 160, and the like.

A wireless communications function of the terminal 100 may be implemented by using the antenna 1, the antenna 2, the mobile communications module 150, the wireless communications module 160, the modem processor, the baseband processor, and the like.

The antenna 1 and the antenna 2 are configured to transmit and receive electromagnetic wave signals. Each antenna in the terminal 100 may be configured to cover one or more communications frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communications module 150 may provide a wireless communications solution that includes 2G/3G/4G/5G or the like and that is applied to the electronic device 100. The mobile communications module 150 is configured to perform the data transmission resumption method performed by the terminal 100 in embodiments of this application.

The wireless communications module 160 may provide a wireless communications solution that is applied to the terminal 100 and that includes a wireless local area network (wireless local area network, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like.

The terminal 100 may implement a display function by using the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, which execute program instructions to generate or change display information. The display 194 is configured to display an image, a video, and the like.

The terminal 100 may implement a photographing function through the ISP, the camera 193, the video codec, the GPU, the display 194, the application processor, and the like.

The ISP may be configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 may be configured to capture a static image or a video. An optical image of an object is generated through the lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the terminal 100 may include one or N cameras 193, where N is a positive integer greater than 1.

The digital signal processor is configured to process a digital signal, and may process another digital signal in addition to the digital image signal. For example, when the terminal 100 selects a frequency, the digital signal processor is configured to perform Fourier transformation on frequency energy.

The video codec is configured to compress or decompress a digital video. The terminal 100 may support one or more video codecs. In this way, the electronic device 100 may play back or record videos in a plurality of coding formats, for example, moving picture experts group (moving picture experts group, MPEG) 1, MPEG 2, MPEG 3, and MPEG 4.

The NPU is a neural-network (neural-network, NN) computing processor. The NPU quickly processes input information by referring to a structure of a biological neural network, for example, a transfer mode between human brain neurons, and may further continuously perform self-learning. Applications such as intelligent cognition of the terminal 100 may be implemented through the NPU, for example, image recognition, facial recognition, speech recognition, and text understanding

The external memory interface 120 may be used to connect to an external memory card, for example, a micro SD card, to extend a storage capability of the terminal 100. The external memory card communicates with the processor 110 through the external memory interface 120, to implement a data storage function. For example, files such as music and videos are stored in the external memory card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the terminal 100, and the like. In addition, the internal memory 121 may include a high-speed random access memory, or may include a nonvolatile memory, for example, at least one magnetic disk storage device, a flash memory, or a universal flash storage (universal flash storage, UFS). The processor 110 runs instructions stored in the internal memory 121 and/or instructions stored in the memory disposed in the processor, to perform various function applications and data processing of the terminal 100.

The terminal 100 may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may be further configured to code and decode audio signals. In some embodiments, the audio module 170 may be disposed in the processor 110, or some functional modules in the audio module 170 are disposed in the processor 110.

The speaker 170A, also referred to as a “loudspeaker”, is configured to convert an audio electrical signal into a sound signal. The terminal 100 may be used to listen to music or answer a call in a hands-free mode over the speaker 170A.

The receiver 170B, also referred to as an “earpiece”, is configured to convert an electrical audio signal into a sound signal. When a call is answered or speech information is received through the terminal 100, the receiver 170B may be put close to a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. At least one microphone 170C may be disposed in the terminal 100. In some other embodiments, two microphones 170C may be disposed in the terminal 100, to collect a sound signal and implement a noise reduction function. In some other embodiments, three, four, or more microphones 170C may alternatively be disposed in the terminal 100, to collect a sound signal, implement noise reduction, and identify a sound source, to implement a directional recording function, and the like. In this embodiment, after the terminal 100 is connected to a recording device 200, the microphone 170C of the terminal 100 does not work.

The headset jack 170D is configured to connect to a wired headset. The headset jack 170D may be a USB interface 130, or may be a 3.5 mm open mobile terminal platform (open mobile terminal platform, OMTP) standard interface or cellular telecommunications industry association of the USA (cellular telecommunications industry association of the USA, CTIA) standard interface.

It may be understood that the structure shown in this embodiment of this application does not constitute a specific limitation on the terminal 100. In some other embodiments of this application, the terminal 100 may include more or fewer components than those shown in the figure, or some components may be combined, or some components may be split, or there may be a different component layout. The components shown in the figure may be implemented by hardware, software, or a combination of software and hardware.

The foregoing descriptions about implementations allow a person skilled in the art to understand that, for the purpose of convenient and brief description, division into the foregoing function modules is taken as an example for illustration. During actual application, the foregoing functions can be allocated to different modules and implemented according to a requirement, that is, an inner structure of an apparatus is divided into different function modules to implement all or some of the functions described above.

In the several embodiments provided in this application, it should be understood that the disclosed apparatus and method may be implemented in other manners. For example, the described apparatus embodiment is merely an example. For example, division into the modules or the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, function units in embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in a form of a software functional unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in the form of a software product. The software product is stored in a storage medium and includes several instructions for instructing a device (which may be a single-chip microcomputer, a chip, or the like) or a processor (processor) to perform all or some of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1-14. (canceled)

15. A network connection control method, applied to a terminal, wherein the method comprises:
detecting, by the terminal, that link quality of a data link of the terminal does not meet a specified quality condition; and
performing, when a dual connectivity function is not activated and the terminal is not in a call state, a first operation to activate the dual connectivity function of the terminal, wherein the first operation is disconnecting, by the terminal, from a 4G network in an access network, and requesting to reconnect to a 5G network and the 4G network in the access network; or
performing, by the terminal when the dual connectivity function is activated, a second operation to re-access a Non-Standalone (NSA) network, wherein the second operation is disconnecting, by the terminal, from a 5G network in a first 5G serving cell, and re-establishing a connection to the 5G network in a second 5G serving cell.

16. The method according to claim 15, wherein the method further comprises:
when the terminal performs the first operation for more than a first quantity of execution times or first execution duration, and the terminal detects that the link quality of the data link of the terminal does not meet the specified quality condition, or
when the terminal performs the second operation for more than a second quantity of execution times or second execution duration, and the terminal detects that the link quality of the data link of the terminal does not meet the specified quality condition:
enabling, by the terminal, the dual connectivity function of the terminal after disabling the dual connectivity function of the terminal for a first disabling duration.

17. The method according to claim 15, wherein the detecting, by the terminal, that link quality of the data link of the terminal does not meet the specified quality condition comprises at least one of the following:
detecting, by the terminal, that a TCP retransmission rate is higher than a retransmission rate threshold;
detecting, by the terminal, that the terminal receives no downlink data packet or sends no uplink data packet in a first preset transmission duration; and
detecting, by the terminal, that a ratio of a quantity of uplink data packets sent by the terminal in a second preset transmission duration to a quantity of downlink data packets received by the terminal in the second preset transmission duration is greater than a first ratio threshold or is less than a second ratio threshold, wherein the first ratio threshold is greater than the second ratio threshold.

18. The method according to claim 15, wherein the terminal performs the first operation in the following manner:
disconnecting, by the terminal from the 4G network by releasing an air interface link of a master base station in the access network; and
accessing the master base station and a core network corresponding to the access network by sending a connection request to the master base station, and accessing the core network corresponding to the access network by using a secondary base station in the access network, to activate the dual connectivity function.

19. The method according to claim 15, wherein the terminal performs the second operation in the following manner:
reporting, by the terminal, a secondary cell group failure to a master base station in the access network, and disconnecting from the 5G network by disconnecting from a secondary base station in the access network;
skipping, by the terminal in preset sending duration, sending a neighboring cell measurement report of a secondary cell group related to the first 5G serving cell to the master base station, so that the master base station changes a 5G serving cell of the terminal from the first 5G serving cell to the second 5G serving cell; and
establishing, by the terminal, the connection to the 5G network in the second 5G serving cell.

20. The method according to claim 16, wherein the enabling, by the terminal, the dual connectivity function of the terminal after disabling the dual connectivity function of the terminal for first disabling duration comprises:
reporting, by the terminal, a secondary cell group failure to a master base station in the access network, to disconnect from a secondary base station in the access network and disable the dual connectivity function, and sending a neighboring cell measurement report of the secondary cell group to the master base station after the first disabling duration to enable the dual connectivity function; or
initiating, by the terminal when the terminal is in a connection idle state, tracking area updating and reporting that the terminal does not support the dual connectivity function, and after the first disabling duration, re-initiating tracking area updating and reporting that the terminal supports the dual connectivity function, to enable the dual connectivity function; or
sending, by the terminal, a first detach message to a core network corresponding to the access network, to disconnect the terminal from the master base station and the core network, and disable the dual connectivity function; and establishing, by the terminal, a connection to the master base station, and reporting, by sending a first attach message to the master base station, that the terminal does not support the dual connectivity function, so that the terminal is connected only to the 4G network; sending, by the terminal after the first disabling duration, a second detach message to the master base station, to disconnect the terminal from the master base station and the core network, re-establishing a connection to the master base station, and reporting, by sending a second attach message to the master base station, that the terminal supports the dual connectivity function, so as to enable the dual connectivity function.

21. A network connection control method, applied to a terminal, wherein the method comprises:
detecting, by the terminal, that link quality of a data link of the terminal does not meet a specified quality condition; and
performing a third operation when the terminal is not in a call state, wherein the third operation is disconnecting, by the terminal, from a 5G network in a 5G system of an access network, lowering a priority of a third 5G serving cell to which the terminal currently belongs, and re-establishing a connection to the 5G network in the 5G system by using a fourth 5G serving cell; or
performing, by the terminal, a fourth operation when the terminal is in the call state, wherein the fourth operation is disconnecting and re-establishing, by the terminal, a data transmission session with a base station in the 5G system.

22. The method according to claim 21, wherein the method further comprises:
when the terminal performs the third operation for more than a third quantity of execution times or third execution duration, and the terminal detects that the link quality of the data link of the terminal does not meet the specified quality condition, or
when the terminal performs the fourth operation for more than a fourth quantity of execution times or fourth execution duration, and the terminal detects that the link quality of the data link of the terminal does not meet the specified quality condition,
enabling, by the terminal, a 5G function of the terminal after disabling the 5G function of the terminal for a second disabling duration.

23. The method according to claim 21, wherein the detecting, by the terminal, that link quality of the data link of the terminal does not meet the specified quality condition comprises at least one of the following:
detecting, by the terminal, that a TCP retransmission rate is higher than a retransmission rate threshold;
detecting, by the terminal, that the terminal receives no downlink data packet or sends no uplink data packet in first preset transmission duration; and
detecting, by the terminal, that a ratio of a quantity of uplink data packets sent by the terminal in a second preset transmission duration to a quantity of downlink data packets received by the terminal in the second preset transmission duration is greater than a first ratio threshold or is less than a second ratio threshold, wherein the first ratio threshold is greater than the second ratio threshold.

24. The method according to claim 21, wherein the terminal performs the third operation in the following manner:
disconnecting, by the terminal, from the 5G network by releasing an air interface link of the base station in the 5G system, and lowering the priority of the third 5G serving cell by sending, to the base station, a measurement report that indicates poor signal quality of the third 5G serving cell; and
sending, by the terminal, a connection request to the base station, to establish the connection to the 5G network by using the fourth 5G serving cell.

25. The method according to claim 21, wherein the terminal performs the fourth operation in the following manner:
disconnecting, by the terminal, a protocol data unit session with the base station in the 5G system; and
re-establishing, by the terminal, the protocol data unit session with the base station in the 5G system.

26. The method according to claim 22, wherein the enabling, by the terminal, the 5G function of the terminal after disabling the 5G function of the terminal for second disabling duration comprises:
sending, by the terminal, a third detach message to the base station in the 5G system, to disconnect the terminal from the base station in the 5G system, and disable the 5G function of the terminal; establishing, by the terminal, a connection to a base station in a non-5G system, and reporting, by sending a third attach message to the base station in the non-5G system, that the terminal does not support the 5G function; and sending, by the terminal, a fourth detach message to the non-5G system after the second disabling duration, to disconnect the terminal from the base station in the non-5G system, and reporting, by sending a fourth attach message to the base station in the 5G system, that the terminal supports the 5G function, to enable the 5G function of the terminal.

27. A computer-readable storage medium, wherein the computer-readable storage medium stores instructions, and when the instructions are executed on a terminal, the terminal is enabled to perform the following steps:
detecting that link quality of a data link of the terminal does not meet a specified quality condition; and
performing, when a dual connectivity function is not activated and the terminal is not in a call state, a first operation to activate the dual connectivity function of the terminal, wherein the first operation is disconnecting, by the terminal, from a 4G network in an access network, and requesting to reconnect to a 5G network and the 4G network in the access network; or
performing, when the dual connectivity function is activated, a second operation to re-access a Non-Standalone (NSA) network, wherein the second operation is disconnecting from a 5G network in a first 5G serving cell, and re-establishing a connection to the 5G network in a second 5G serving cell.

28. The computer-readable storage medium according to claim 27, when the instructions are executed on a terminal, the terminal is further enabled to perform the following steps:
when the terminal performs the first operation for more than a first quantity of execution times or first execution duration, and the terminal detects that the link quality of the data link of the terminal does not meet the specified quality condition, or
when the terminal performs the second operation for more than a second quantity of execution times or second execution duration, and the terminal detects that the link quality of the data link of the terminal does not meet the specified quality condition:
enabling the dual connectivity function of the terminal after disabling the dual connectivity function of the terminal for a first disabling duration.

29. The computer-readable storage medium according to claim 27, wherein the detecting that link quality of the data link of the terminal does not meet the specified quality condition comprises at least one of the following:
detecting that a TCP retransmission rate is higher than a retransmission rate threshold;
detecting that the terminal receives no downlink data packet or sends no uplink data packet in a first preset transmission duration; and
detecting that a ratio of a quantity of uplink data packets sent by the terminal in a second preset transmission duration to a quantity of downlink data packets received by the terminal in the second preset transmission duration is greater than a first ratio threshold or is less than a second ratio threshold, wherein the first ratio threshold is greater than the second ratio threshold.

30. The computer-readable storage medium according to claim 27, wherein the terminal performs the first operation in the following manner:
disconnecting from the 4G network by releasing an air interface link of a master base station in the access network; and
accessing the master base station and a core network corresponding to the access network by sending a connection request to the master base station, and accessing the core network corresponding to the access network by using a secondary base station in the access network, to activate the dual connectivity function.

31. The computer-readable storage medium according to claim 27, wherein the terminal performs the second operation in the following manner:
reporting a secondary cell group failure to a master base station in the access network, and disconnecting from the 5G network by disconnecting from a secondary base station in the access network;
skipping in preset sending duration, sending a neighboring cell measurement report of a secondary cell group related to the first 5G serving cell to the master base station, so that the master base station changes a 5G serving cell of the terminal from the first 5G serving cell to the second 5G serving cell; and
establishing the connection to the 5G network in the second 5G serving cell.

31. The computer-readable storage medium according to claim 28, wherein the enabling the dual connectivity function of the terminal after disabling the dual connectivity function of the terminal for first disabling duration comprises:
reporting a secondary cell group failure to a master base station in the access network, to disconnect from a secondary base station in the access network and disable the dual connectivity function, and sending a neighboring cell measurement report of the secondary cell group to the master base station after the first disabling duration to enable the dual connectivity function; or
initiating, when the terminal is in a connection idle state, tracking area updating and reporting that the terminal does not support the dual connectivity function, and after the first disabling duration, re-initiating tracking area updating and reporting that the terminal supports the dual connectivity function, to enable the dual connectivity function; or
sending, a first detach message to a core network corresponding to the access network, to disconnect the terminal from the master base station and the core network, and disable the dual connectivity function; and establishing a connection to the master base station, and reporting, by sending a first attach message to the master base station, that the terminal does not support the dual connectivity function, so that the terminal is connected only to the 4G network; sending, after the first disabling duration, a second detach message to the master base station, to disconnect the terminal from the master base station and the core network, re-establishing a connection to the master base station, and reporting, by sending a second attach message to the master base station, that the terminal supports the dual connectivity function, so as to enable the dual connectivity function.
